(19) United States
(12) Patent Application Publication
(10) Pub. No.: US 2015/0234897 A1
(43) Pub. Date: Aug. 20, 2015

(54) TIME SERIES DATA PROCESSING APPARATUS AND METHOD, AND STORAGE MEDIUM

(71) Applicant: HITACHI, LTD., Chiyoda-ku, Tokyo (JP)

(72) Inventors: Yasuo Kuninobu, Tokyo (JP); Masashi Egi, Tokyo (JP); Naohiro Suzuki, Tokyo (JP)

(73) Assignee: Hitachi, Ltd., Chiyoda-ku, Tokyo (JP)

(21) Appl. No.: 14/428,275

(22) PCT Filed: Jan. 10, 2013
(86) PCT No.: PCT/JP2013/050337

§ 371 Date: Mar. 13, 2015

(51) Int. Cl. G06F 17/30

(52) U.S. Cl. CPC G06F 17/30477

(57) ABSTRACT

An unnecessary load is prevented from being applied to the system even in cases where the time series data required for the time series data analysis processing has not been collected. A time series data processing apparatus assigns an arrival time, which is a time that the time series data arrived, to the time series data sent from the data source, determines whether the requested time series data has arrived, and predicts the arrival time of the time series data, which was determined by the data arrival determination unit as not yet arrived, based on the arrival time assigned to each of the time series data.

### TECHNICAL FIELD

The present invention relates to a time series data processing apparatus and method, and a storage medium, and, for example, can be suitably applied to a time series data processing apparatus for processing time series data, which is series of data sent from a data source such as a sensor over time.

### BACKGROUND ART

In recent years, efforts for incorporating measured values periodically acquired by various sensors as time series data in a computer system, and utilizing such time series data have begun. Moreover, due to the price reduction of sensors, the applicability thereof is increasing, and time series data can now be collected from devices in various environments. For example, there are cases of collecting time series data of operational history and GPS (Global Positioning System) position information from devices in environments of mines and tunnels, and utilizing such time series data for the preventive maintenance of railways and construction machinery.

Upon collecting time series data from the foregoing devices, there are cases where the computer system is unable to collect the time series data even after the lapse of the measurement time. One cause of this problem is that, due to the device being moved, the connection of the network becomes temporarily unavailable.

Thus, there are cases where a part of the time series data becomes missing or the time series data is collected belatedly, and there are now problems in that the computer system is unable to execute the analytical processing which uses such time series data. Thus, several time series data processing systems have been proposed for dealing with the foregoing data omission or delay.

For example, PTL 1 discloses a technology of retrying the collection processing after the lapse of a predetermined time when the collection of time series data was unsuccessful in order to inhibit the omission of time series data. Moreover, PTL 2 discloses a technology for notifying the user of the omission of time series data to be analyzed when the analysis of the time series data was unsuccessful in order to prevent the repeated failure in analyzing the time series data.

### CITATION LIST

### Patent Literature

[PTL 1] Pamphlet of International Publication No. 2011/158372

[PTL 2] Japanese Patent Application Publication No. H10-243366

### SUMMARY OF INVENTION

### Technical Problem

However, according to the technology disclosed in PTL 1, in certain cases the retry of the collection processing is repeated, and there is a problem in that an unnecessary load is applied to the system. Moreover, according to the technology disclosed in PTL 2, since it is not possible to confirm the time that all time series data will be complete only based on the omission information of the time series data, it is necessary to repeatedly confirm the collection result of the time series data and, consequently, an unnecessary load is applied to the system as with PTL 1.

The present invention was devised in view of the foregoing points, and an object of this invention is to propose a time series data processing apparatus and method, and a storage medium capable of preventing an unnecessary load from being applied to the system even in cases where the time series data required for the time series data analysis processing has not been collected.

### Solution to Problem

In order to resolve the foregoing problems, the present invention provides a time series data processing apparatus for processing time series data, which is series of data sent from a data source over time, comprising an arrival time assignment unit for assigning an arrival time, which is a time that the time series data arrived, to the time series data sent from the data source, a data arrival determination unit for determining whether the requested time series data has arrived, and an arrival time prediction unit for predicting the arrival time of the time series data, which was determined by the data arrival determination unit as not yet arrived, based on the arrival time assigned to each of the time series data.

Moreover, the present invention additionally provides a time series data processing method that is executed in a time series data processing apparatus for processing time series data, which is series of data sent from a data source over time, comprising a first step whereby the time series data processing apparatus assigns an arrival time, which is a time that the time series data arrived, to the time series data sent from the data source, a second step whereby the time series data processing apparatus determines whether the requested time series data has arrived, and a third step whereby the time series data processing apparatus predicts the arrival time of the time series data, which was determined by the data arrival determination unit as not yet arrived, based on the arrival time assigned to each of the time series data.

Furthermore, the present invention additionally provides a storage medium storing a computer program to be executed in a time series data processing apparatus for processing time series data, which is series of data sent from a data source over time, wherein the computer program causes the time series data processing apparatus to execute a first step of assigning an arrival time, which is a time that the time series data arrived, to the time series data sent from the data source, a second step of determining whether the requested time series data has arrived, and a third step of predicting the arrival time of the time series data, which was determined by the data arrival determination unit as not yet arrived, based on the arrival time assigned to each of the time series data.

Consequently, according to the time series data processing apparatus, the time series data processing method and the storage medium of the present invention, since the user of the time series data can comprehend the time that all time series data required for the processing will be complete, it is possible to prevent that user from blindly repeating the retry processing for obtaining all time series data.

### Advantageous Effects of Invention

According to the present invention, it is possible to prevent an unnecessary load from being applied to the system even in cases where the time series data required for the time series data analysis processing has not been collected.

### BRIEF DESCRIPTION OF DRAWINGS

FIG. 1 is a block diagram showing the schematic configuration of the computer system according to the first to third embodiments.

FIG. 2 is a block diagram showing the configuration of the time series data processing apparatus according to the first embodiment.

FIG. 3 is a conceptual diagram showing the schematic configuration of the time series data.

FIG. 4 is a conceptual diagram showing the schematic configuration of the analytical query.

FIG. 5 is a conceptual diagram showing the configuration of the data table with arrival time according to the first embodiment.

FIG. 6 is a conceptual diagram showing the configuration of the measurement time rule table according to the first embodiment.

FIG. 7 is a conceptual diagram showing the configuration of the arrival time prediction model table according to the first embodiment.

FIG. 8 is a flowchart showing the processing routine of the data collection processing according to the first embodiment.

FIG. 9 is a flowchart showing the processing routine of the data analysis processing according to the first embodiment.

FIG. 10 is a flowchart showing the processing routine of the query result creation processing according to the first embodiment.

FIG. 11 is a schematic wiring diagram showing a schematic configuration example of the data analysis screen.

FIG. 12 is a block diagram showing the configuration of the time series data processing apparatus according to the second embodiment.

FIG. 13 is a conceptual diagram showing the configuration of the measurement time rule table according to the second embodiment.

FIG. 14 is a conceptual diagram showing the configuration of the arrival time prediction model table according to the second embodiment.

FIG. 15 is a conceptual diagram showing the configuration of the data table with arrival time according to the second embodiment.

FIG. 16 is a flowchart showing the processing routine of the data collection processing according to the second embodiment.

FIG. 17 is a flowchart showing the processing routine of the query result creation processing according to the second embodiment.

FIG. 18 is a flowchart showing the processing routine of the scheduled transfer time calculation processing.

FIG. 19 is a block diagram showing the configuration of the time series data processing apparatus according to the third embodiment.

FIG. 20 is a conceptual diagram showing the configuration of the arrival time prediction model table according to the third embodiment.

FIG. 21 is a flowchart showing the processing routine of the query result creation processing according to the third embodiment.

FIG. 22 is a flowchart showing the processing routine of the data transfer time determining factor determination processing.

FIG. 23 is a diagram showing a creation example of the histogram of the transfer time.

FIG. 24 is a diagram showing an arithmetic expression for calculating the intragroup distribution.

FIG. 25 is a diagram representing an arithmetic expression for calculating the inter-group distribution.

FIG. 26 is a diagram representing an arithmetic expression for calculating the degree of separation between groups.

### DESCRIPTION OF EMBODIMENTS

An embodiment of the present invention is now explained in detail with reference to the drawings.

### (1) First Embodiment

### (1-1) Configuration of Computer System According to the Present Embodiment

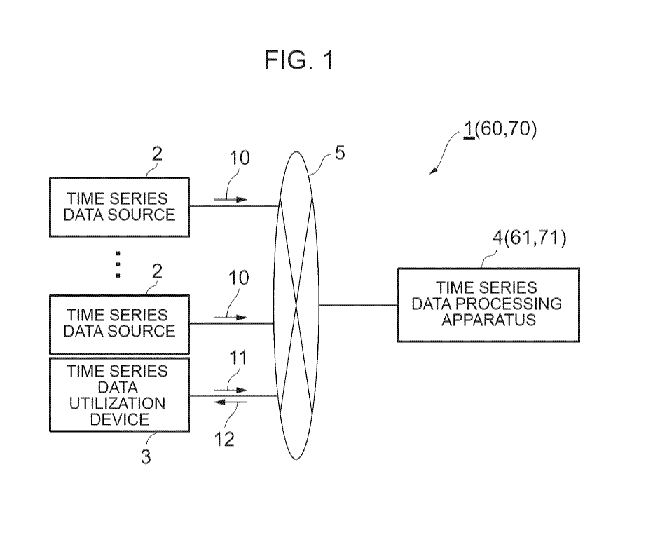

FIG. 1 shows an overall computer system 1 according to the present embodiment. The computer system 1 comprises at least one or more time series data sources 2, a time series data utilization device 3 and a time series data processing apparatus 4, and is configured by these components being mutually connected via a network 5.

The time series data source 2 is configured from, for example, a temperature sensor, a humidity sensor, a velocity sensor or a position sensor. The time series data source 2 periodically measures the temperature, humidity, velocity or position, and sends the measured value as time series data 10 to the time series data processing apparatus 4.

The time series data utilization device 3 is a computer device comprising information processing resources such as a processor and a memory, and is configured from, for example, a personal computer. The time series data utilization device 3 is loaded with, for example, an application program (hereinafter simply referred to as the “program”) such as a browser to become a data I/O interface between the time series data utilization device 3 and the time series data processing apparatus 4.

In addition, the time series data utilization device 3 issues an analytical query 11 as an analysis request to the time series data processing apparatus 4 according to instructions given from a user using the browser. Moreover, the time series data utilization device 3 stores, in a storage device, a query result 12 from the time series data processing apparatus 4 in response to the analytical query 11 and provides the query result 12 to the user as needed.

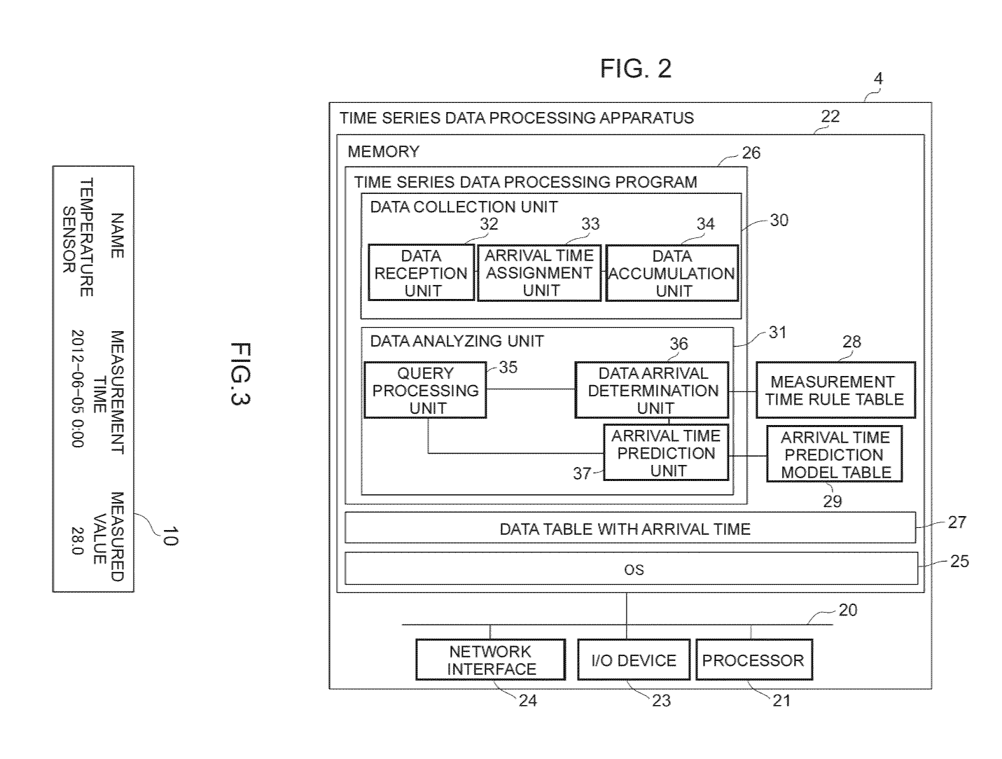

The time series data processing apparatus 4 is a server apparatus for storing and managing the time series data 10 sent from the time series data source 2, and sending, to the time series data utilization device 3, an analytical result according to the analytical query 11 from the time series data utilization device 3 as the query result 12. The time series data processing apparatus 4 is configured, as shown in FIG. 2, by comprising a processor 21, a memory 22, an I/O device 23 and a network interface 24 that are mutually connected via an internal network 20.

The processor 21 has the function of governing the operational control of the overall time series data processing apparatus 4, and is configured from, for example, a CPU (Central Processing Unit) or an MPU (Micro-Processing Unit). The various types of processing described later are executed by the overall time series data processing apparatus 4 as a result of the processor 21 executing the programs stored in the memory 22.

The memory 22 is configured from, for example, a semiconductor memory such as a RAM (Random Access Memory Unit), and stores an OS (Operation Program) 25, other programs, and data such as parameter data and tables to be used by the programs. The time series data processing program 26 described later is also stored and retained in the memory 22.

The I/O device 23 is configured from a data I/O device that is used in general computer devices. For example, as the I/O device 23, adopted may be an input device such as a keyboard, a mouse, a touch screen, or a pen tablet, and an output device such as a display monitor or a printer.

The network interface 24 is an interface circuit for performing data communication with the time series data source 2 and the time series data utilization device 3 via the network 5 (FIG. 1), and an appropriate type is used in accordance with the type of network 5. For example, if the network 5 is a LAN (Local Area Network), an NIC (Network Interface Card) is applied as the network interface 24.

A schematic configuration of the time series data 10 output from the time series data source 2 is shown in FIG. 3. As shown in FIG. 3, the time series data 10 includes the following types of information; namely, a name, a measurement time and a measured value. The name represents the type of sensor of the sender's time series data source 2, the measurement time represents the time that the measurement was performed, and the measured value represents the sensor value that was acquired in the measurement. Accordingly, FIG. 3 shows a configuration example of the time series data 10 storing a measured value of “28.0” acquired by a “temperature sensor” at the measurement time of “2012-06-05 0:00”.

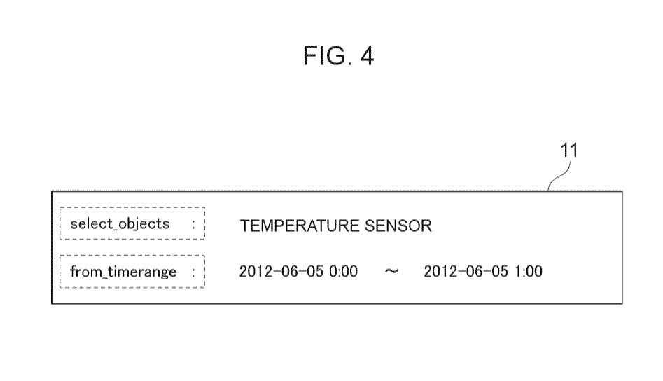

Moreover, a schematic configuration of the analytical query 11 sent from the time series data utilization device 3 to the time series data processing apparatus 4 is shown in FIG. 4. As evident from FIG. 4, the analytical query 11 includes the following types of information; namely, a selection object (select_objects) and a data acquisition target time range (from_timerange). The selection object represents the time series data source 2 requesting the transfer of the measured value, and the data acquisition target time range represents the temporal range of the measured value for which the transfer was requested. Accordingly, FIG. 4 shows a configuration example of the analytical query 11 that requested the transfer of the measured value acquired by a “temperature sensor” between “2012-06-05 0:00” and “2012-06-05 1:00”.

### (1-2) Time Series Data Processing Method According to the Present Embodiment

The time series data processing function equipped in the time series data processing apparatus 4 according to the present embodiment is now explained. The time series data processing apparatus 4 is equipped with a time series data processing function in which, when the analytical query 11 designating the time series data source 2 to be targeted and the data acquisition target time range is provided to the time series data utilization device 3 and the time series data 10 storing the measured value acquired from the time series data source 2 at the measurement time within the data acquisition target time range has not yet arrived, the time that the time series data 10, which has not yet arrived, is expected to arrive is predicted, and the prediction result is notified to the time series data utilization device 3.

As means for realizing the foregoing time series data processing function, the memory 22 of the time series data processing apparatus 4 stores, as shown in FIG. 2, a time series data processing program 26, a data table with arrival time 27, a measurement time rule table 28 and an arrival time prediction model table 29.

The time series data processing program 26 is a program for causing the time series data processing apparatus 4 to exhibit the time series data processing function, and is configured from a data collection unit 30 for collecting the time series data 10 that is periodically sent from the respective time series data sources 2, and a data analyzing unit 31 for predicting the arrival time of the not-yet-arrived time series data 10 based on the collected time series data 10.

The data collection unit 30 is configured from a data reception unit 32, an arrival time assignment unit 33 and a data accumulation unit 34. The data reception unit 32 is an object having a function of receiving the time series data 10 sent from the respective time series data sources 2 in order of arrival, and outputting the received time series data 10 to the arrival time assignment unit 33.

Moreover, the arrival time assignment unit 33 is an object having a function of assigning, to the time series data 10 that was provided from the data reception unit 32, a time that the time series data 10 was received by the time series data processing apparatus 4 as the arrival time. In addition, the data accumulation unit 34 is an object having a function of registering, in the data table with arrival time 27 described later, the time series data 10 provided from the arrival time assignment unit 33.

Moreover, the data analyzing unit 31 is configured from a query processing unit 35, a data arrival determination unit 36 and an arrival time prediction unit 37. The query processing unit 35 is an object having a function of acquiring, from the data table with arrival time 27, information of the time series data 10 that was designated in the analytical query 11 from the time series data utilization device 3, and sending the acquired information as the query result 12 to the time series data utilization device 3.

Moreover, the data arrival determination unit 36 is an object having a function of referring to the measurement time rule table 28 described later and identifying the time series data 10 to be acquired from the data table with arrival time 27 based on the selection object and the data acquisition target time range designated in the analytical query 11 upon the query processing unit 35 acquiring, from the data table with arrival time 27, information of the time series data 10 that was designated in the analytical query 11.

The arrival time prediction unit 37 is an object having a function of referring to the arrival time prediction model table 29 described later and predicting the arrival time of the time series data 10 when the time series data 10 identified by the data arrival determination unit 36 has not yet arrived.

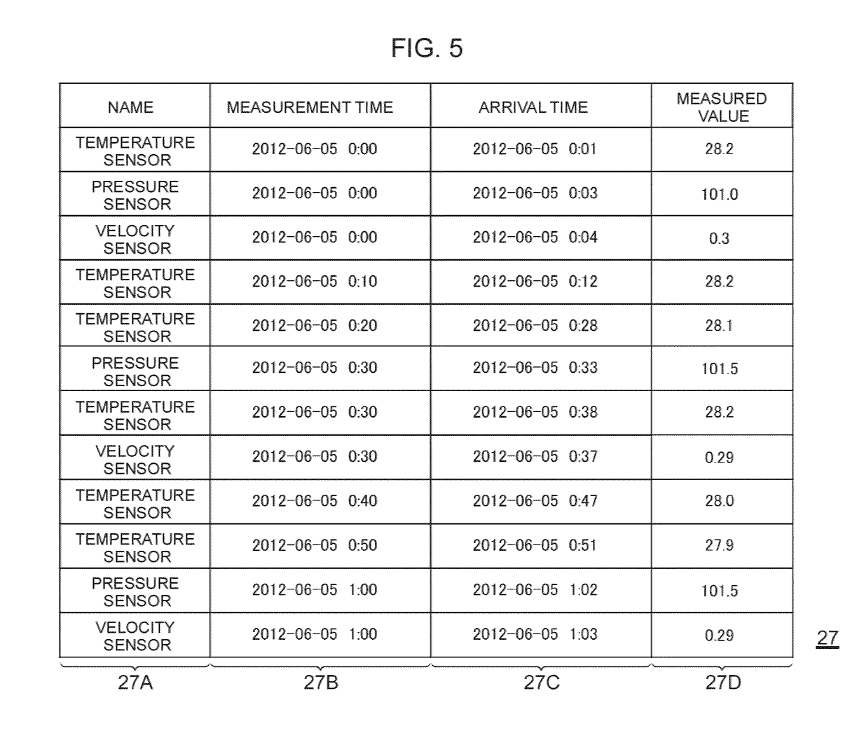

Meanwhile, the data table with arrival time 27 is a table that is used for storing and managing the time series data 10 that was received by the time series data processing apparatus 4, and is configured from, as shown in FIG. 5, a name column 27A, a measurement time column 27B, an arrival time column 27C and a measured value column 27D.

The name column 27A stores the name (sensor type) of the time series data source 2 of the sender of the received time series data 10, and the measurement time column 27B stores the measurement time (refer to FIG. 3) that was stored in the corresponding time series data 10. Moreover, the arrival time column 270 stores the time that the time series data 10 was received by the time series data processing apparatus 4, and the measured value column 27D stores the measured value (refer to FIG. 3) that was stored in that time series data 10.

Accordingly, FIG. 5 shows a case where, for example, the arrival time at the time series data processing apparatus 4 of the time series data 10 storing the measured Value of “28.2” that was measured by a “temperature sensor” at “2012-06-05 0:00” is “2012-06-05 0:01”, the arrival time at the time series data processing apparatus 4 of the time series data 10 storing the measured value of “101.0” that was measured by a “pressure sensor” at “2012-06-05 0:00” is “2012-06-05 0:03”, and the arrival time at the time series data processing apparatus 4 storing the time series data 10 storing the measured value of “0.3” that was measured by a “velocity sensor” at “2012-06-05 0:00” is “2012-06-05 0:04”.

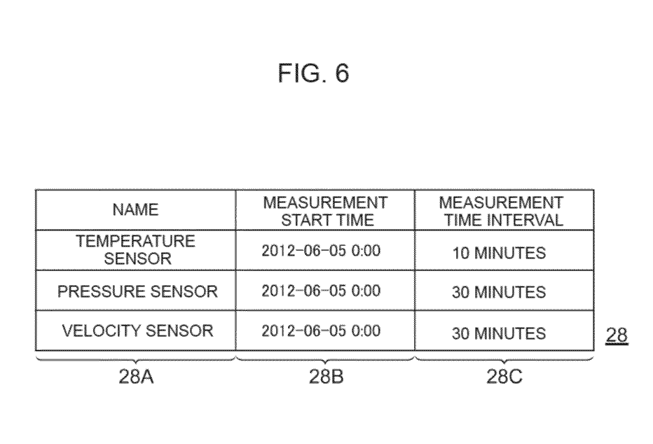

Moreover, the measurement time rule table 28 is a table for managing the measurement start time and the measurement time interval of the respective time series data sources 2, and is configured from, as shown in FIG. 6, a name column 28A, a measurement start time column 28B and a measurement time interval column 28C.

The name column 28A stores the name (sensor type) of the respective time series data sources 2, and the measurement start time column 28B stores the time that was pre-set as the time that the corresponding time series data source 2 starts the acquisition (starts the measurement) of the measured value. Moreover, the measurement time interval column 28C stores the time interval in which the corresponding time series data source 2 is to acquire the measured value and send the measured value as the time series data 10 to the time series data processing apparatus 4.

Accordingly, FIG. 6 shows a cases where a “temperature sensor”, a “pressure sensor” and a “velocity sensor” exist as the time series data sources 2, and, among the above, the temperature sensor is set to sent the measured value as the time series data 10 to the time series data processing apparatus 4 every “10 minutes” from “2012-06-05 0:00”.

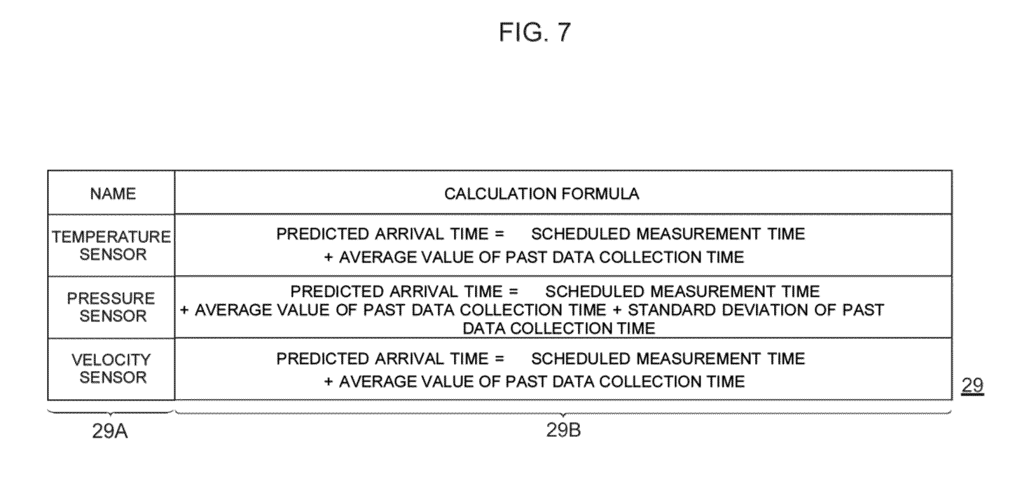

Moreover, the arrival time prediction model table 29 is a table for managing the calculation method of the predicted arrival time of each time series data source 2, and is configured from, as shown in FIG. 7, a name column 29A and a calculation method column 29B. The name column 29A stores the name of the corresponding time series data source 2, and the calculation method column 29B stores the calculation method for calculating the predicted arrival time of the time series data 10, in which the arrival is delayed, that was pre-set regarding the corresponding time series data source 2.

In the case of the present embodiment, the foregoing calculation method differs between the temperature sensor/velocity sensor and the pressure sensor, and, for example, the calculation formula is prescribed as follows for a temperature sensor and a wind sensor.

[Math 1]

Predicted Arrival Time=Scheduled Measurement Time+Average Value of Past Data Collection Time (1)

In other words, in the case of the present embodiment, the predicted arrival time of the time series data 10, in which the arrival is delayed, that is calculated by a temperature sensor or a wind sensor is calculated as the sum of the scheduled time of acquiring the measured value stored in that time series data 10 (hereinafter referred to as the “scheduled measurement time”) and the average value of the past data collection time. Note that the term “data collection time” refers to the time from the measurement time that the time series data source 2 acquired the measured value up to the arrival of the time series data 10 storing the measured value at the time series data processing apparatus 4. In the ensuing explanation, this data collection time is referred to as the “transfer time” as appropriate.

### (1-3) Various Types of Processing Related to Time Series Data Processing Function

The processing routine of various types of processing to be executed in the time series data processing apparatus 4 in relation to the time series data processing function is now explained. Note that, in the ensuing explanation, while the processing routine of various types of processing is explained as a “ . . . unit” (that is, object), in reality, it goes without saying that such processing is executed by the processor 21 (FIG. 2) based on that object.

### (1-3-1) Data Collection Processing

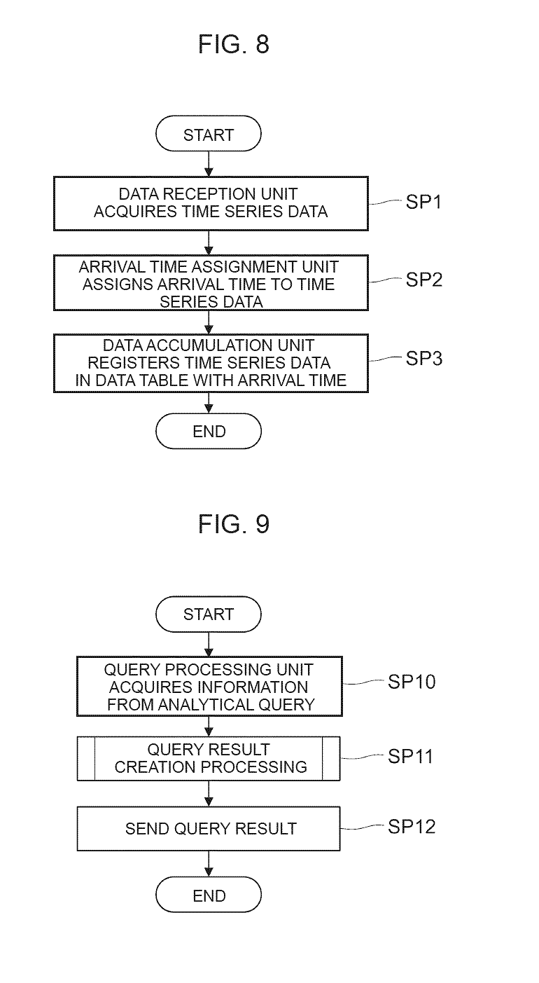

FIG. 8 shows the processing routine of the data collection processing that is executed in the data collection unit 30 of the time series data processing program 26 when the time series data 10 from the time series data source 2 is received by the time series data processing apparatus 4. The data collection unit 30 registers, according to the processing routine shown in FIG. 8, the received time series data 10 in the data table with arrival time 27.

In reality, when the time series data 10 from the time series data source 2 is received by the time series data processing apparatus 4, the received time series data 10 is received by the data reception unit 32 of the data collection unit 30. The data reception unit 32 provides the received time series data 10 to the arrival time assignment unit 33 (SP1).

Moreover, the arrival time assignment unit 33 assigns, to the time series data 10 provided from the data reception unit 32, the time that the time series data 10 arrived at the time series data processing apparatus 4, and provides the time series data 10 to which the arrival time was assigned to the data accumulation unit 34 (SP2). In addition, the data accumulation unit 34 registers, in the data table with arrival time 27, the time series data 10 provided from the arrival time assignment unit 33 (SP3). The data collection processing performed in the data collection unit 30 is thereby ended.

### (1-3-2) Data Analysis Processing

FIG. 9 shows the processing routine of the data analysis processing that is executed in the data analyzing unit 31 of the time series data processing program 26 when the analytical query 11 from the time series data utilization device 3 is received by the time series data processing apparatus 4. The data analyzing unit 31 generates the query result 12 in accordance with the received analytical query 11 and sends the generated query result 12 to the time series data utilization device 3 according to the processing routine shown in FIG. 9.

In reality, the query processing unit 35 of the data analyzing unit 31 acquires the name and the data acquisition target time range of the time series data source 2 of the selection object from the received analytical query 11 (hereinafter referred to as the “target time series data source 2”) (SP10).

Subsequently, the data analyzing unit 31 creates the query result 12 including all measured values that the target time series data source 2 acquired within the data acquisition target time range based on the coordinated processing of the query processing unit 35, the data arrival determination unit 36 and the arrival time prediction unit 37 (SP11). The query processing unit 35 sends the created query result 12 to the time series data utilization device 3 (SP12). The data analysis processing performed in the data analyzing unit 31 is thereby ended.

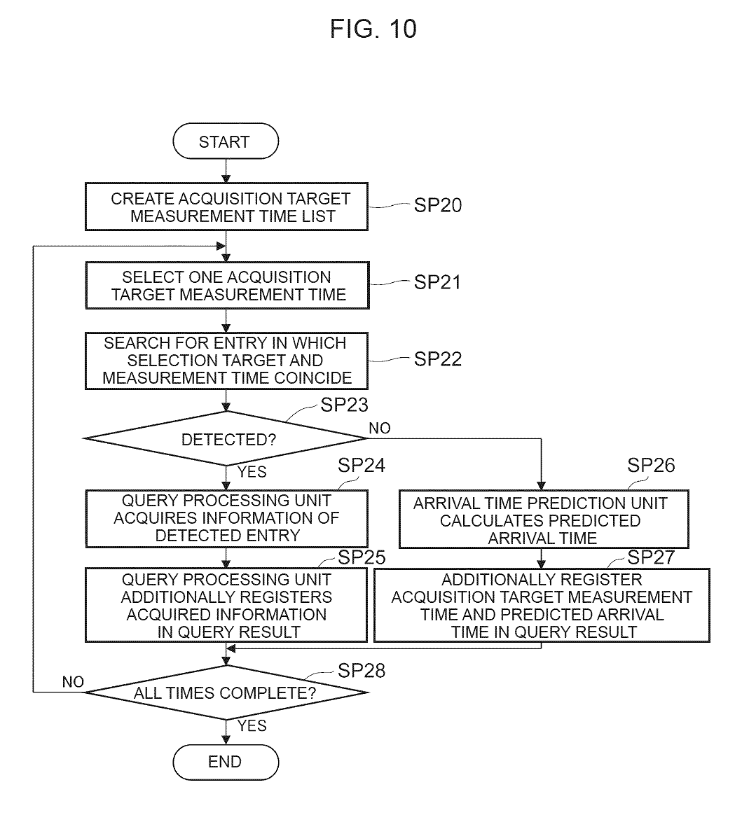

The specific processing contents of the query result creation processing that is executed by the query processing unit 35, the data arrival determination unit 36 and the arrival time prediction unit 37 in step SP11 of the data analysis processing are shown in FIG. 10.

When the routine proceeds to step SP11 of the data analysis processing (FIG. 9), the query result creation processing shown in FIG. 10 is started, and the data arrival determination unit 36 foremost creates the acquisition target measurement time list (not shown) listing all measurement times within the data acquisition target time range designated in the analytical query 11 as the acquisition target measurement time based on the measurement start time stored in the measurement start time column 28B and the measurement time interval stored in the measurement time interval column 28C of the measurement time rule table 28 (FIG. 6) (SP20).

For example, when the target time series data source 2 designated in the analytical query 11 is a “temperature sensor” and the data acquisition target time range is “2012-06-05 0:00 to 2012-06-05 1:00” as shown in FIG. 3, upon referring to the measurement time rule table 28 of FIG. 6, since the measurement time interval of a “temperature sensor” is “10 minutes”, “2012-06-05 0:00”, “2012-06-05 0:10”, “2012-06-05 0:20”, “2012-06-05 0:30”, “2012-06-05 0:40”, “2012-06-05 0:50” and “2012-06-05 1:00” will be the acquisition target measurement times. Thus, the data arrival determination unit 36 creates, as the acquisition target measurement time list, a list which lists the foregoing acquisition target measurement times in time order.

Subsequently, the data arrival determination unit 36 selects one acquisition target measurement time from the acquisition target measurement time list in which the time is the earliest and which has not yet been processed (SP21), and searches, from the data table with arrival time 27, for an entry (line) in which the name of the target time series data source 2 is stored in the name column 27A, and the same measurement time as the acquisition target measurement time selected in step SP21 is stored in the measurement time column 27B (SP22).

Moreover, the data arrival determination unit 36 determines whether it was possible to detect, based on the search of step SP22, an entry in which the name of the target time series data source 2 is stored in the name column 27A, and the same measurement time as the acquisition target measurement time selected in step SP21 is stored in the measurement time column 27B (SP23).

When a positive result is obtained in the foregoing determination, the query processing unit 35 acquires, from the data table with arrival time 27, the measurement time stored in the measurement time column 27B and the measured value stored in the measured value column 27D of the detected entry (SP24), and additionally registers the acquired measurement time and measured value in the query result 12 (SP25).

Thereafter, the data arrival determination unit 36 determines whether the processing of step SP22 onward has been executed for all acquisition target measurement times listed in the acquisition target measurement time list created in step SP20 (SP28). When a negative result is obtained in the foregoing determination, the routine returns to step SP21, and thereafter repeats step SP21 onward while sequentially switching the acquisition target measurement time selected in step SP21 to another unprocessed acquisition target measurement time.

Meanwhile, when a negative result is obtained in the determination of step SP23, it is determined that the time series data 10 storing the measured value acquired at the corresponding acquisition target measurement time has not yet arrived at the time series data processing apparatus 4. Consequently, the arrival time prediction unit 37 calculates the predicted arrival time of that time series data 10 based on the corresponding calculation method stored in the arrival time prediction model table 29 (SP26). Subsequently, the query processing unit 35 additionally registers the calculated predicted arrival time, and the acquisition target measurement time of the measured value stored in that time series data 10 in the query result 12 (SP27).

Thereafter, the query processing unit 35 determines whether the processing of step SP21 onward has been executed for all acquisition target measurement times listed in the acquisition target measurement time list created in step SP20 (SP28). When a negative result is obtained in the foregoing determination, the routine returns to step SP21 and thereafter repeats step SP21 onward while sequentially switching the acquisition target measurement time in step SP21 to another unprocessed acquisition target measurement time.

When a positive result is obtained in the determination of step SP28 as a result of the execution of processing of step SP21 onward eventually being completed for all acquisition target measurement times listed in the acquisition target measurement time created in step SP20, the data analyzing unit 31 ends the query result creation processing, and returns to the data analysis processing (FIG. 9).

### (1-4) Data Analysis Screen

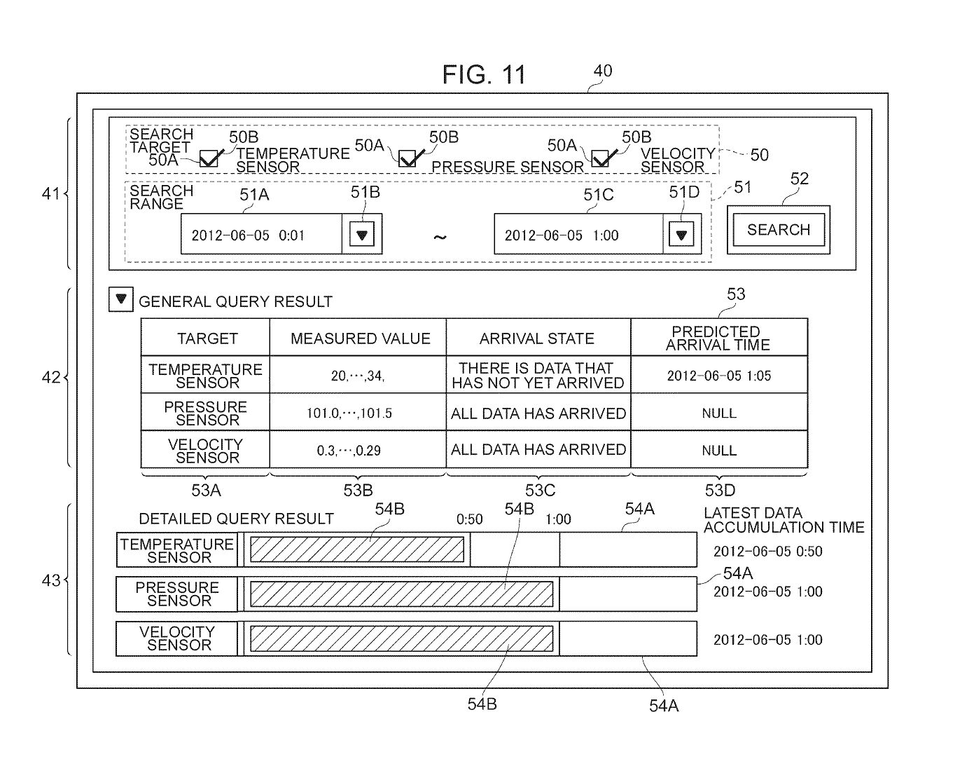

FIG. 11 shows a configuration example of the data analysis screen 40 that can be displayed on the I/O device 23 (FIG. 2) of the time series data utilization device 3 or the time series data processing apparatus 4 based on the query result 12 created according to the data analysis processing described above with reference to FIG. 9. The data analysis screen 40 is configured from an analytical range field 41, a general query result field 42 and a detailed query result field 43.

The analytical range field 41 is a field for designating the time series data source 2 that requested the measured value (selection object of the analytical query 11) and the temporal range of the requested measured value (data acquisition target time range of the analytical query 11), and configured from a search target designation area 50, a search range designation area 51 and a search button 52.

In addition, the search target designation area 50 displays check boxes 50A each indicating the name (sensor type) of the respective time series data sources 2, and each associated with such name. In the search target designation area 50, by clicking the check box 50A, the time series data source 2 in which the measured value and the like are to be displayed in the general query result field 42 described above can be selected, and a check mark 50B can be displayed in the check box 50A (that is, clicked check box 50A) corresponding to the selected time series data source 2.

Moreover, the search range designation area 51 is provided with a range start time designation column 51A and a first pull-down button 518, and by clicking the first pull-down button 518, it is possible to display a first pull-down menu (not shown) listing the times that are selectable as the start time of the data acquisition target time range. In addition, by selecting the intended time among the times displayed in the first pull-down menu, that time can be designated as the start time of the data acquisition target time range, and the designated start time is displayed in the range start time designation column 51A.

Similarly, the search range designation area 51 is provided with a range end time designation column 51C and a second pull-down button 51D, and by clicking a second pull-down button 51D, it is possible to display a second pull-down menu (not shown) listing the times that are selectable as the end time of the data acquisition target time range. In addition, by selecting the intended time among the times displayed in the second pull-down menu, that time can be designated as the end time of the data acquisition target time range, and the designated end time is displayed in the range end time designation column 51C.

On the data analysis screen 40, by displaying the check mark 50B in the check box 50A associated with the intended time series data source 2 among the check boxes 50A displayed in the search target designation area 50, and additionally displaying the start time and the end time of the data acquisition target time range respectively in the range start time designation column 51A and the range end time designation column 51C within the search range designation area 51 and subsequently clicking the search button 52, the time series data processing apparatus 4 can thereby create the query result 12 storing information such as the measured value that the time series data source 2 acquired within the data acquisition target time range, and the contents of the query result 12 can be displayed within the general query result field 42 as described later.

In reality, displayed in the general query result field 42 is a query result list 53 configured from a target column 53A, a measured value column 53B, an arrival state column 53C and a predicted arrival time column 53D.

Subsequently, the name of the time series data source 2 designated in the analytical range field 41 as described above is displayed in the target column 53A of the query result list 53, and all measured values that the corresponding time series data source 2 acquired within the corresponding data acquisition target time range are respectively displayed in the measured value column 53B.

Moreover, the arrival state column 53C stores information representing whether all measured values (time series data 10) within the corresponding data acquisition target time range of the corresponding time series data source 2 have arrived at the time series data processing apparatus 4. Specifically, when all measured values (time series data 10) within the corresponding data acquisition target time range of the corresponding time series data source 2 have not arrived at the time series data processing apparatus 4, a character string of “there is data that has not yet arrived” is displayed in the arrival state column 53C, and when all measured values (time series data 10) have arrived at the time series data processing apparatus 4, a character string of “all data have arrived” is displayed in the arrival state column 53C.

In addition, when all measured values (time series data 10) within the corresponding data acquisition target time range of the corresponding time series data source 2 have not arrived at the time series data processing apparatus 4 (when the character string of “there is data that has not yet arrived” is being displayed in the arrival state column 53C), the predicted arrival time of the measured value (time series data 10) that has not yet arrived is displayed in the predicted arrival time column 53D. Moreover, when all measured values (time series data 10) within the corresponding data acquisition target time range of the corresponding time series data source 2 have arrived at the time series data processing apparatus 4 (when the character string of “all data have arrived” is being displayed in the arrival state column 53C), a character string of “NULL” is displayed in the predicted arrival time column 53D.

Meanwhile, the arrival status of the measured values (time series data 10) within the data acquisition target time range at the time series data processing apparatus 4 is displayed in the detailed query result field 43. Specifically, in the detailed query result field 43, a timeline 54A associated with each time series data source 2 designated in the analytical range field 41 as described above is displayed, and a bar graph 54B representing to which acquisition target measurement time the measured values (time series data 10) have arrived at the time series data processing apparatus 4 within the data acquisition target time range for each time series data source 2 is displayed in the timeline 54A.

Moreover, displayed on the right side of each timeline 54A is, as the latest data accumulation time, the last acquisition target measurement time among the acquisition target measurement times within the data acquisition target time range in which the corresponding time series data 10 has already arrived at the time series data processing apparatus 4 with regard to each of the corresponding time series data sources 2.

### (1-5) Effect of the Present Embodiment

With the computer system 1 according to the present embodiment as described above, since the time series data processing apparatus 4 can predict the arrival time of the time series data 10 that has not yet arrived at the time series data processing apparatus 4, and present the result to the time series data utilization device 3 or the user, the time series data utilization device 3 or the user can easily comprehend the time that all time series data required for the processing will be complete.

According to the computer system 1, it is possible to prevent the time series data utilization device 3 or the user from blindly repeating the retry processing for obtaining all time series data, and, consequently, it is possible to prevent an unnecessary load from being applied to the system even in cases where the time series data required for the time series data analysis processing has not been collected.

Moreover, since the time that all time series data required for the processing will be complete can be easily comprehended with the computer system 1, the time series data utilization device 3 or the user can make business decisions such as giving priority to other data analysis processing without waiting for the time that all data will be complete, and the processing and work efficiency can be improved.

### (2) Second Embodiment

### (2-1) Configuration of Computer System According to the Present Embodiment

FIG. 1 shows an overall computer system 60 according to the second embodiment. The computer system 60 is configured in the same manner as the computer system 1 according to the first embodiment excluding the point that the time series data source 2 collectively transfers the time series data 10 at the appointed time, and the point that the predicted arrival time of the time series data 10 is consequently calculated according to a method that is different from the first embodiment in the time series data processing apparatus 61.

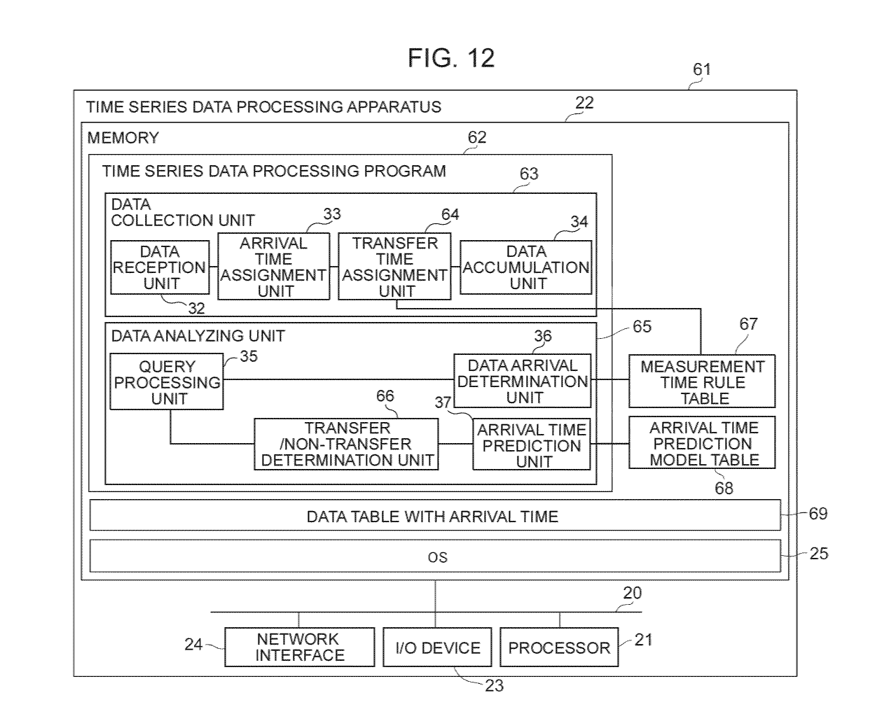

FIG. 12, in which the same reference numeral is given to a component corresponding to the component of FIG. 1, shows the configuration of the time series data processing apparatus 61 according to the second embodiment. As shown in FIG. 12, with the time series data processing apparatus 61, a transfer time assignment unit 64 is provided to the data collection unit 63 of the time series data processing program 62. The transfer time assignment unit 64 is an object having a function of assigning, to the time series data 10 to which the arrival time output from the arrival time assignment unit 33 has been assigned, the time (hereinafter referred to as the “transfer time”) that the time series data source 2 sent the time series data 10 to the time series data processing apparatus 61.

Moreover, with the time series data processing apparatus 61, a transfer/non-transfer determination unit 66 is provided to the data analyzing unit 65 of the time series data processing program 62. The transfer/non-transfer determination unit 66 is an object having a function of referring to the measurement time rule table 67 described later, and calculating the scheduled transfer time (hereinafter referred to as the “scheduled transfer time”) of the time series data in which the selection objection designated in the received analytical query 11 is the sender, and which stores the measured value in which the measurement time is within the data acquisition target time range designated in the analytical query 11.

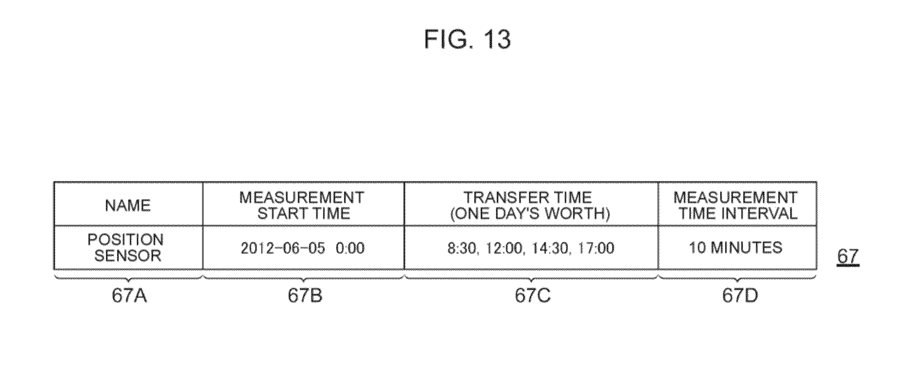

FIG. 13 shows the configuration of the measurement time rule table 67 according to the second embodiment. As evident from FIG. 13, the measurement time rule table 67 is configured from a name column 67A, a measurement start time column 67B, a transfer time column 67C and a measurement time interval column 67D.

The name column 67A, the measurement start time column 67B and the measurement time interval column 67D respectively store the same information as the information that is respectively stored in the name column 28A, the measurement start time column 28B and the measurement time interval column 28C of the first embodiment described above with reference to FIG. 6.

Moreover, the transfer time column 67C stores all times of a predetermined day (each time is hereinafter referred to as the “default transfer time”) as the time that the corresponding time series data source 2 should collectively transfer the not-yet-transferred time series data 10 to the time series data processing apparatus 61.

Accordingly, FIG. 13 shows an example where, with regard to a “position sensor”, the measurement start time is “2012-06-05 0:00”, the measurement time interval is set to “10 minutes”, and the default transfer times of the time series data 10 are set to “8:30”, “12:00”, “14:30” and “17:00”.

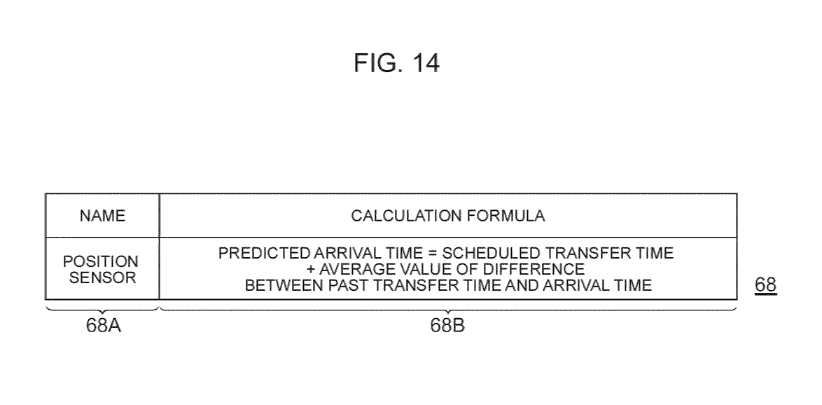

Meanwhile, FIG. 14 shows the configuration of the arrival time prediction model table 68 according to the present embodiment. As with the arrival time prediction model table 29 (FIG. 7) according to the first embodiment, the arrival time prediction model table 68 is also a table for managing the predicted arrival time and calculation method for each time series data source 2, and is configured from, as shown in FIG. 14, a name column 68A and a calculation method column 68B. The name column 68A stores the name (sensor type) of the corresponding time series data source 2, and the calculation method column 68B manages the calculation method, which was pre-set for the corresponding time series data source 2, for calculating the predicted arrival time of the time series data 10 in which the arrival is delayed.

The calculation method in the present embodiment is prescribed as being the following formula.

[Math 2]

Predicted Arrival Time=Scheduled Transfer Time+Average Value of Difference Between Past Transfer Time and Arrival Time (2)

In other words, in the present embodiment, the predicted arrival time of the time series data 10 in which the arrival is delayed is calculated as the sum of the scheduled transfer time of the time series data 10, and the average value of the difference between the past transfer time and arrival time (that is, time from the time that the time series data source 2 sent the time series data 10 up to the time that the time series data 10 arrives at the time series data processing apparatus 61).

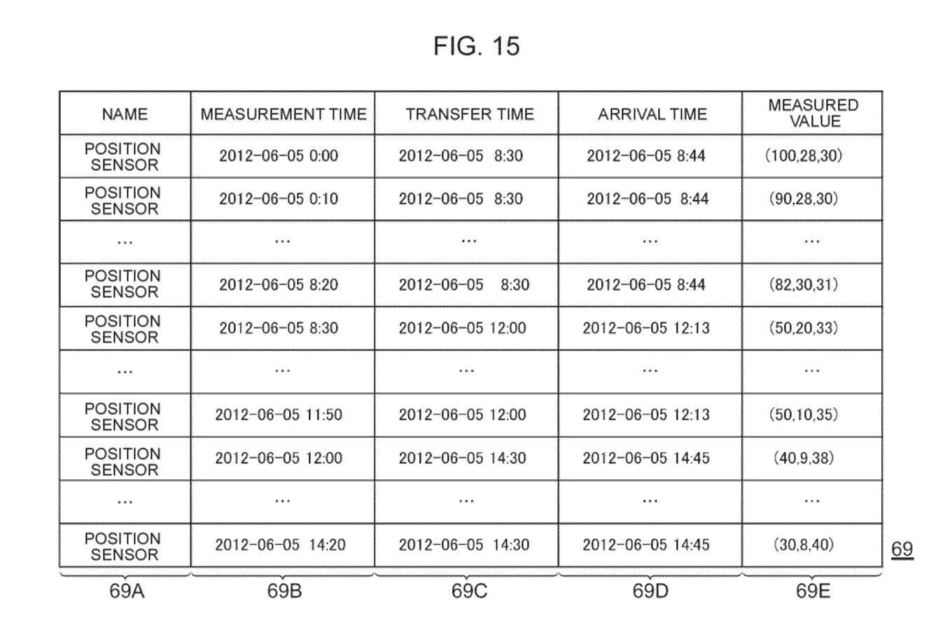

Meanwhile, FIG. 15 shows the configuration of the data table with arrival time 69 according to the present embodiment. As with the data table with arrival time 27 according to the first embodiment described above with reference to FIG. 5, the data table with arrival time 69 is a table for storing and managing the time series data 10 from the respective time series data sources 2 received by the time series data processing apparatus 61, and is configured from, as shown in FIG. 15, a name column 69A, a measurement time column 69B, a transfer time column 69C, an arrival time column 69D and a measured value column 69E.

The name column 69A, the measurement time column 69B and the arrival time column 69D respectively store the same information as the information that is respectively stored in the name column 27A, the measurement time column 27B and the arrival time column 27C of the data table with arrival time 27 according to the first embodiment described above with reference to FIG. 5. Moreover, the transfer time column 69C stores the transfer time of the corresponding time series data 10, and the measured value column 69E stores the corresponding time series data 10 and all measured values that were respectively stored in all other time series data 10 received together with the foregoing corresponding time series data 10.

Accordingly, FIG. 15 shows that, for example, the time series data 10 storing the measured value that was measured by the “position sensor” at “2012-06-05 0:00” was transferred from that “position sensor” to the time series data processing apparatus 61 at “2012-06-05 8:30”, the arrival time of that time series data 10 at the time series data processing apparatus 61 was “2012-06-05 8:44”, and the measured values stored in the plurality of acquired time series data 10 were respectively “100”, “28” and “30”.

### (2-2) Data Collection Processing

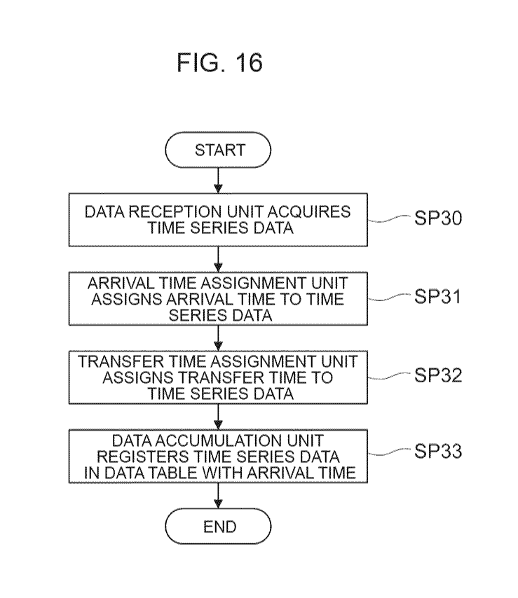

FIG. 16 shows the processing routine of the data collection processing that is executed in the data collection unit 63 (FIG. 12) of the present embodiment when the time series data 10 from the time series data source 2 is received by the time series data processing apparatus 61. The data collection unit 63 registers the received time series data 10 in the data table with arrival time 15 according to the processing routine shown in FIG. 16.

In reality, when the time series data processing apparatus 61 receives the time series data 10 from the time series data source 2, the data collection processing shown in FIG. 16 is started, and the data collection unit 63 of the time series data processing program 62 executes step SP30 and step SP31 in the same manner as step SP1 and step SP2 of the data collection processing of the first embodiment described above with reference to FIG. 8.

Consequently, the one or more time series data 10 received by the time series data processing apparatus 61 will be received by the data reception unit 32 of the data collection unit 63 (SP30), and an arrival time is assigned to each of those time series data 10 (SP31).

Subsequently, the transfer time assignment unit 64 of the data collection unit 63 assigns as the transfer time, to each of the time series data 10 to which the arrival time provided from the arrival time assignment unit 33 was assigned, a default transfer time among the default transfer times stored in the corresponding transfer time column 67C of the measurement time rule table 67 (FIG. 13) which is later than the measurement time stored in that time series data 10 and which is closest to that measurement time.

Specifically, for example, when the name of the time series data source 2 stored in the time series data 10 is “position sensor” and the default transfer times of the position are “8:30”, “12:00”, “14:30” and “17:00” as shown in FIG. 13, the transfer time assignment unit 64 assigns “8:30” as the transfer time to that time series data 10 when the measurement time stored in that time series data 10 is “17:00” to “8:30” (but not including “8:30”), and assigns “12:00” as the transfer time to that time series data 10 when the measurement time stored in that time series data 10 is “8:30” to “12:00” (but not including “12:00”). Moreover, the transfer time assignment unit 64 assigns “14:30” as the transfer time to that time series data 10 when the measurement time stored in that time series data 10 is “12:00” to “14:30” (but not including “14:30”), and assigns “17:00” as the transfer time to that time series data 10 when the measurement time stored in that time series data 10 is “14:30” to “17:00” (but not including “17:00”).

The transfer time assignment unit 64 thereafter provides the respective time series data 10, to which the transfer time was assigned, to the data accumulation unit 34 (SP32).

Moreover, the data accumulation unit 34 additionally registers the respective time series data 10, to which the transfer time provided from the transfer time assignment unit 64 was assigned, in the data table with arrival time 69 (FIG. 15) (SP33). The data collection unit 63 thereby ends the data collection processing.

### (2-3) Query Result Creation Processing

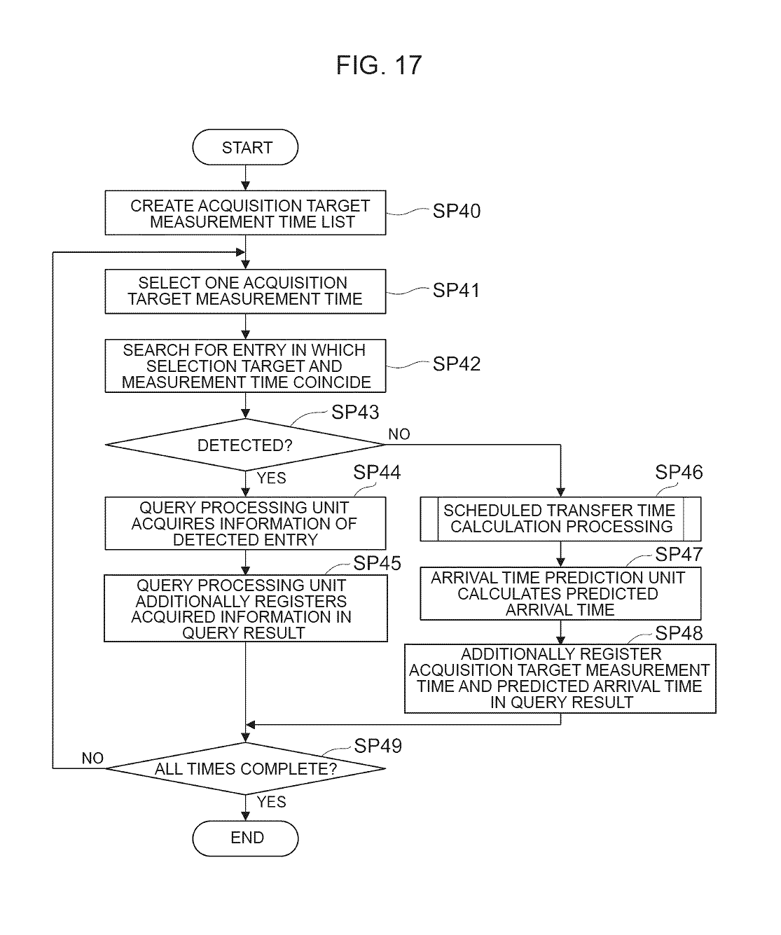

FIG. 17 shows the processing routine of the query result creation processing according to the present embodiment that is executed by the data analyzing unit 65 (FIG. 12) in step SP11 of the data analysis processing described above with reference to FIG. 9 in substitute for the query result creation processing according to the first embodiment described above with reference to FIG. 10.

In the case of the present embodiment, when the data analyzing unit 65 proceeds to step SP11 of the data analysis processing (FIG. 9), the data analyzing unit 65 starts the query result creation processing shown in FIG. 17, and executes step SP40 to step SP43 in the same manner as step SP20 to step SP23 of the query result creation processing of the first embodiment.

Consequently, an acquisition target measurement time list is created (SP40), and one unprocessed acquisition target measurement time is selected among the acquisition target measurement times listed in that acquisition target measurement time list (SP41). Moreover, subsequently, an entry (line) storing the same name as the target time series data source 3 in the name column 69A of the data table with arrival time 69 (FIG. 15), and storing the same measurement time as the acquisition target measurement time selected in step SP41 in the measurement time column 69B is searched (SP42), and whether such an entry was detected is determined (SP43).

When a positive result is obtained in the determination of step SP43, step SP44 onward are executed in the same manner as step SP24 onward of the query result creation processing of the first embodiment. Consequently, the acquisition target measurement time selected in step SP41 and the measured value acquired at that acquisition target measurement time (measurement time) are additionally registered in the query result (SP44, SP45).

Meanwhile, when a negative result is obtained in the determination of step SP43, the transfer/non-transfer determination unit 66 executes the scheduled transfer time calculation processing of calculating the scheduled transfer time of the time series data 10 storing the measured value in the acquisition target measurement time selected in step SP41 (SP46).

Subsequently, the arrival time prediction unit 37 uses the scheduled transfer time calculated in the scheduled transfer time calculation processing of step SP46, and calculates the predicted arrival time of the time series data 10 storing the measured value at the acquisition target measurement time selected in step SP41 based on the corresponding calculation method stored in the arrival time prediction model able 68 (FIG. 14) (SP47).

Thereafter, step SP48 onward are executed in the same manner as step SP27 onward of the query result creation processing (FIG. 10) of the first embodiment. When a positive result is obtained in the determination of step SP49 as a result of the processing of step SP41 onward eventually being executed for all acquisition target measurement times listed in the acquisition target measurement time list, the data analyzing unit 65 ends the query result creation processing, and returns to the data analysis processing (FIG. 9).

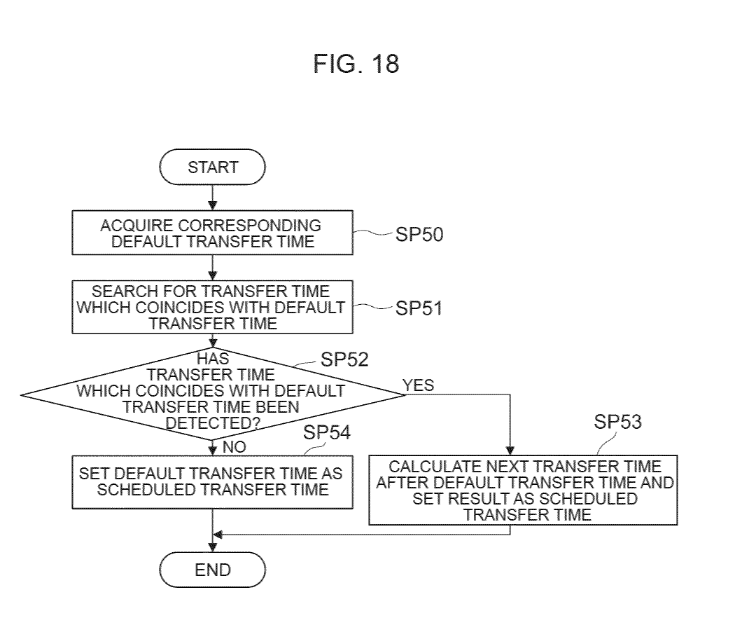

FIG. 18 shows the specific processing routine of the scheduled transfer time calculation processing that is executed by the transfer/non-transfer determination unit 66 (FIG. 12) in step SP46 of the query result creation processing.

When the routine proceeds to step SP46 of the query result creation processing, the transfer/non-transfer determination unit 66 starts the scheduled transfer time calculation processing shown in FIG. 18, and foremost acquires, as the scheduled transfer time of the time series data 10 storing the measured value acquired at the acquisition target measurement time, a default transfer time among the default transfer times stored in the corresponding transfer time column 67C of the measurement time rule table 67 (FIG. 13) that is later than the targeted acquisition target time (acquisition target measurement time selected in step SP41 of the query result creation processing) and closest to that acquisition target time (SP50).

For example, when the time series data source 2 designated as the selection object in the analytical query 11 is a “position sensor” and the acquisition target time selected in step SP41 of the query result creation processing is “2012-06-05 14:10”, the default transfer time among the default transfer times stored in the corresponding transfer time column 67C of the measurement time rule table 67 that is later than “2012-06-05 14:10” and closest to “2012-06-05 14:10” is “2012-06-05 14:30”. Thus, in the foregoing case, the transfer/non-transfer determination unit 66 will acquire “2012-06-05 14:30”.

Subsequently, the transfer/non-transfer determination unit 66 searches for an entry (line) from the data table with arrival time 69 (FIG. 15) in which the sensor type stored in the name column 69A coincides with the name of the time series data source 2 designated as the selection object in the analytical query 11, and in which the transfer time stored in the transfer time column 69C coincides with the default transfer time acquired in step SP50 (SP51). The transfer/non-transfer determination unit 66 thereafter determines whether such an entry was detected (SP52).

Here, to obtain a positive result in step SP52 means that the time series data processing apparatus 61 has received at least one time series data 10 that was collectively transferred at the same transfer time. Accordingly, it can be considered that the transfer of the time series data 10 storing the measured value acquired at the targeted acquisition target time is delayed due to some kind of factor. In the foregoing case, it is likely that a part of that time series data 10 will be transferred at the next default transfer time.

Consequently, the transfer/non-transfer determination unit 66 reads the “next default transfer time” from the measurement time rule table 67, and sets the read “next default transfer time” as the scheduled transfer time of the time series data 10 storing the measured value acquired at the targeted acquisition target time (SP54). The transfer/non-transfer determination unit 66 thereafter ends the scheduled transfer time calculation processing.

For example, when the time series data source 2 of the selection object designated in the analytical query 11 is a “position sensor”, the default transfer time acquired in step SP50 is “2012-06-05 14:30”, and the data table with arrival time 69 has the contents like those shown in FIG. 15, the transfer/non-transfer determination unit 66 can discover, in the data table with arrival time 69, at least two entries which respectively correspond to the time series data 10 in which the arrival time is “2012-06-05 14:45”. Thus, in the foregoing case, the transfer/non-transfer determination unit 66 reads “2012-06-05 17:00” as the next default transfer time after “2012-06-05 14:30” from the corresponding transfer time column 67C of the measurement time rule table 67, and sets “2012-06-05 17:00” as the scheduled transfer time of the time series data 10 storing the measured value of the targeted acquisition target time.

Meanwhile, to obtain a negative result in step SP52 means that the transfer processing of all time series data 10 to be collectively transferred at the same transfer time is delayed due to some kind of factor, and all of such time series data 10 have not yet arrived at the time series data processing apparatus 61. In the foregoing case, it is difficult to predict when that time series data 10 will arrive at the time series data processing apparatus 61.

Consequently, in the foregoing case, the transfer/non-transfer determination unit 66 sets the default transfer time, which was the transfer time of the time series data 10 storing the measured value acquired at the targeted acquisition target time, as the scheduled transfer time (SP54). The transfer/non-transfer determination unit 66 thereafter ends the scheduled transfer time calculation processing.

For example, when the time series data source of the selection object designated in the analytical query 11 is a “position sensor”, the default transfer time acquired in step SP50 is “2012-06-05 17:00”, and the data table with arrival time 69 has the contents as those shown in FIG. 15, the transfer/non-transfer determination unit 66 is unable to discover an entry, in the data table with arrival time 69, in which the sensory type stored in the name column 69A coincides with the name of the time series data source 2 designated as the selection object in the analytical query 11, and in which the transfer time stored in the transfer time column 69C coincides with the default transfer time acquired in step SP50. Thus, in the foregoing case, the transfer/non-transfer determination unit 66 sets “2012-06-05 17:00” as the scheduled transfer time of the time series data 10 storing the measured value of the targeted acquisition target time.

### (2-4) Effect of the Present Embodiment

With the computer system 60 according to the present embodiment described above, while the time series data source 2 collectively transfers the time series data 10 at the appointed time, as with the computer system 1 of the first embodiment, since the time series data processing apparatus 61 can predict the arrival time of the time series data 10 that has not yet arrived at the time series data processing apparatus 61, and present the result to the time series data utilization device 3 or the user, the time series data utilization device 3 or the user can easily comprehend the time that all time series data required for the processing will be complete.

According to the computer system 60, the same effect as the first embodiment can be obtained even in a system configuration where the time series data source 2 collectively transfers the time series data 10 at the appointed time.

### (3) Third Embodiment

### (3-1) Configuration of Computer System According to the Present Embodiment

FIG. 1 shows an overall computer system 70 according to the third embodiment. The computer system 70 is configured in the same manner as the computer system 1 according to the first embodiment excluding the point that a factor as a time required from a time that the time series data source 2 acquired the measured value to a time that the time series data 10 storing the measured value arrives at the time series data processing apparatus 71 (hereinafter referred to as the “transfer time determining factor”) is determined, the arrival time of that time series data 10 is predicted based on the determination result, and the predicted transfer time determining factor and predicted arrival time are notified as the query result 12 (FIG. 1) to the time series data utilization device 3 (FIG. 1).

In reality, the time series data processing apparatus 71 of the computer system 70 sorts the respective time series data 10 storing the respective measured values that were acquired by the time series data source designated as the selection object in the analytical query 11 at the respective acquisition target measurement time within the data acquisition target time range designated in the analytical query 11 into a plurality of groups (two groups in the ensuing explanation) according to the time (transfer time) that was required for that time series data 10 to arrive at the time series data processing apparatus 71 after measuring the measured value stored in that time series data 10, and estimates the transfer time determining factor for each group.

For example, as the transfer time determining factor of a group in which the transfer time is not that great, a simple “communication delay” can be assumed, and as the transfer time determining factor of a group in which the transfer time is great, a “temporary communication failure” caused by the temporary separation from a communication environment by the time series data source 2, due to the movement of the time series data source 2, can be assumed.

Moreover, the time series data processing apparatus 71 calculates, as the factor determination time, the time in which the distribution between the foregoing groups becomes maximum. In addition, the time series data processing apparatus 71 determines to which group the time series data 10 belongs by comparing the elapsed time up to now and the factor determination time regarding the time series data 10 that has not yet arrived among the time series data 10 respectively storing the measured values acquired by the time series data source 2 designated in the analytical query 11 at the respective acquisition target times within the data acquisition target time range designated in the analytical query 11.

The time series data processing apparatus 71 calculates the average value of the transfer time of the group to which the not-yet-arrived time series data 10 belongs, and calculates the predicted arrival time of the time series data 10 by adding the calculated average value to the scheduled measurement time of the measured value stored in that time series data 10. Moreover, the time series data processing apparatus 71 registers the thus calculated predicted arrival time of the time series data 10 and the assumed transfer time determining factor of the time series data 10 in the query result 12, and sends the query result 12 to the time series data utilization device 3 (FIG. 1).

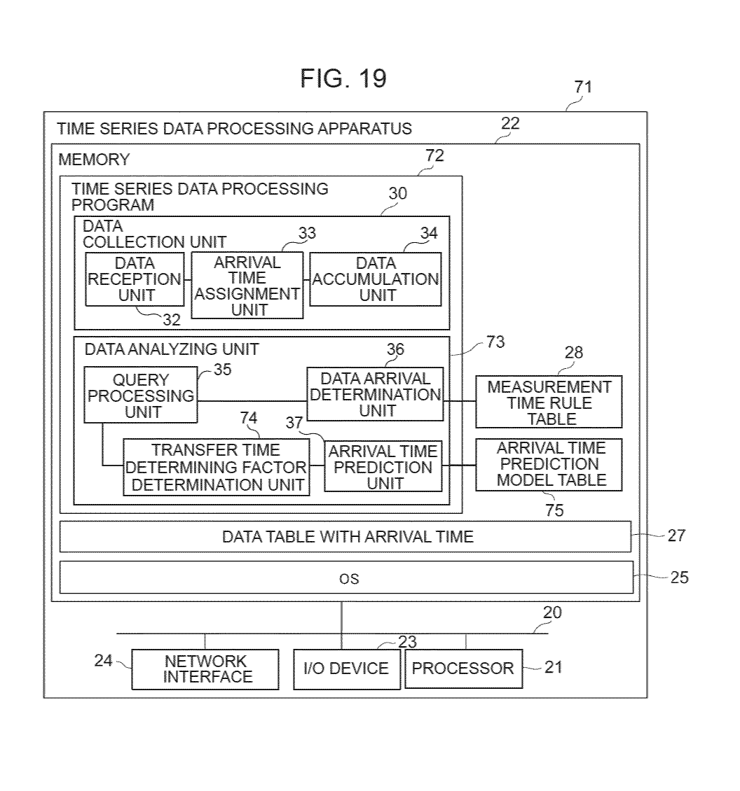

As means for realizing the time series data processing function of the time series data processing apparatus 71 described above, with the time series data processing apparatus 71 according to the present embodiment, a transfer time determining factor determination unit 74 is provided to the data analyzing unit 73 of the time series data processing program 72 as shown in FIG. 19 in which the same reference numeral is given to a component corresponding to the component of FIG. 2.

The transfer time determining factor determination unit 74 is an object having a function of determining the transfer time determining factor of the respective time series data 10 storing the respective measured values acquired by the time series data source 2 designated in the analytical query 11 at the respective acquisition target times within the data acquisition target time range designated in the analytical query 11.

Based on the transfer time determining factor determination unit 74, the respective time series data 10 are grouped into two groups according to the transfer time and the foregoing factor determination time as the temporal threshold between the groups is calculated, and the transfer time determination factor and the predicted arrival time of the not-yet-arrived time series data 10 are estimated and calculated, respectively, based on the factor determination time.

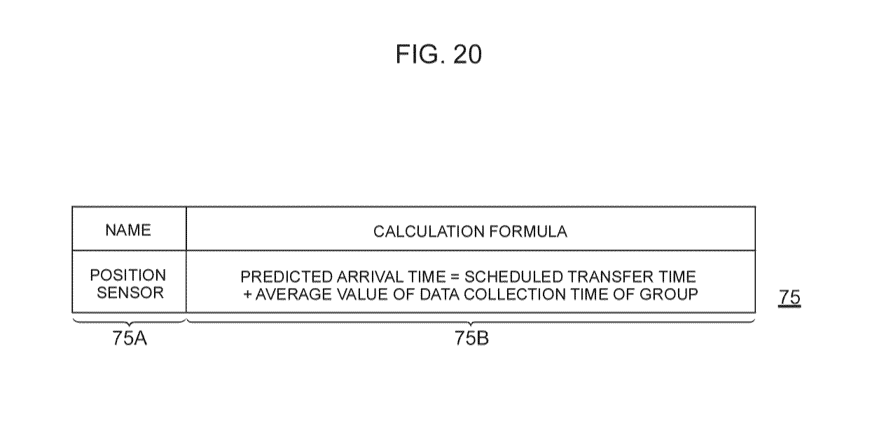

FIG. 20 shows the configuration of the arrival time prediction model table 75 according to the present embodiment. As with the arrival time prediction model table 29 according to the first embodiment described above with reference to FIG. 7, the arrival time prediction model table 75 is a table for managing the calculation method of the predicted arrival time of each time series data source 2, and is configured from, as shown in FIG. 20, a name column 75A and a calculation method column 75B.

The name column 75A stores the name (sensor type) of the corresponding time series data source 2, and the calculation method column 75B stores the calculation method, which was pre-set for the corresponding time series data source 2, for calculating the predicted arrival time of the time series data 10 in which the arrival is delayed.

The calculation method in the present embodiment is prescribed as being the following formula.

[Math 3]

Predicted Arrival Time=Scheduled Measurement Time+Average Value of Data Collection Time in Group (3)

In other words, in the present embodiment, the predicted arrival time of the time series data 10 in which the arrival is delayed is calculated as the sum of the scheduled measurement time of the measured value stored in that time series data 10, and the average value of the data collection time (that is, transfer time) in the group to which that time series data 10 belongs.

### (3-2) Query Result Creation Processing According to the Present Embodiment

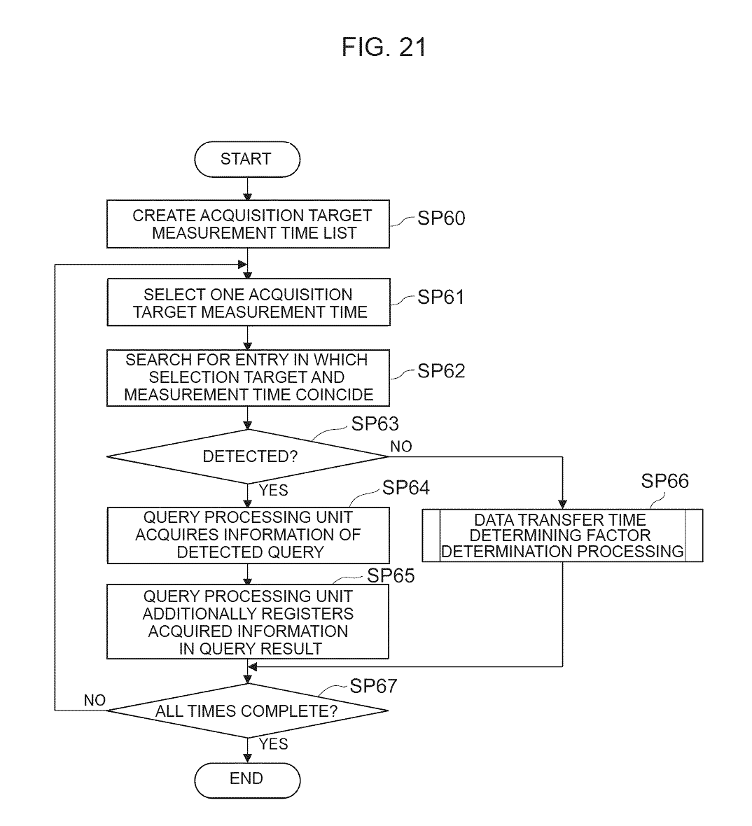

FIG. 21 shows the processing routine of the query result creation processing according to the present embodiment that is executed in step SP11 of the data analysis processing described above with reference to FIG. 9 in substitute for the query result creation processing according to the first embodiment described above with reference to FIG. 10.

When the routine proceeds to step SP11 of the data analysis processing (FIG. 9), the data analyzing unit 73 of the time series data processing program 72 starts the query result creation processing shown in FIG. 21 and executes step SP60 to step SP63 in the same manner as step SP20 to step SP23 of the query result creation processing of the first embodiment.

Consequently, an acquisition target measurement time list is created (SP60), and one unprocessed acquisition target measurement time is selected among the acquisition target measurement times listed in that acquisition target measurement time list (SP61). Moreover, subsequently, an entry (line) storing the same name as the target time series data source 2 in the name column 27A of the data table with arrival time 27 (FIG. 5), and storing the same time as the acquisition target measurement time selected in step SP61 in the measurement time column 27B is searched (SP62), and whether such an entry was detected is determined (SP63).

When a positive result is obtained in the determination of step SP63, step SP64 onward are executed in the same manner as step SP24 onward of the query result creation processing of the first embodiment. Consequently, the acquisition target measurement time selected in step SP61 and the measured value acquired at that acquisition target measurement time are additionally registered in the query result 12 (SP64, SP65).

Meanwhile, when a negative result is obtained in the determination of step SP63, executed is the data transfer time determining factor determination processing in which the data transfer time determining factor of the time series data 10 storing the measured value at the acquisition target measurement time selected in step SP61 is determined, the predicted arrival time of that time series data 10 is estimated based on the determination result, and the estimation result is additionally registered in the query result 12 (SP66).

Thereafter, the data arrival determination unit 36 determines whether the processing of step SP61 onward has been executed for all acquisition target measurement times listed in the acquisition target measurement time list created in step SP60 (SP67). When a negative result is obtained in the foregoing determination, the routine returns to step SP61, and thereafter repeats step SP61 onward while sequentially switching the acquisition target measurement time selected in step SP61 to another unprocessed acquisition target measurement time.

When a positive result is obtained in the determination of step SP67 as a result of the execution of processing of step SP61 onward eventually being completed for all acquisition target measurement times listed in the acquisition target measurement time created in step SP60, the data analyzing unit 31 ends the query result creation processing, and returns to the data analysis processing (FIG. 9).

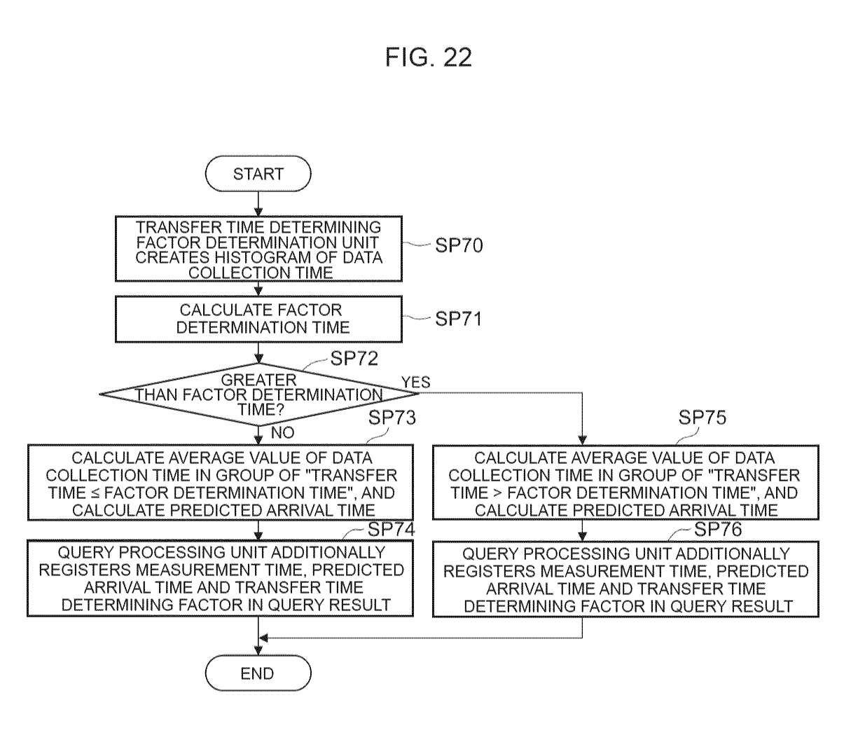

FIG. 22 shows the specific processing routine of the data transfer time determining factor determination processing that is executed in step SP66 of the query result creation processing.

When the routine proceeds to step SP66 of the query result creation processing, the data transfer time determining factor determination processing shown in FIG. 22 is started, and the transfer time determining factor determination unit 74 foremost refers to the data table with arrival time 27 (FIG. 5) and creates a histogram of the transfer time (SP70).

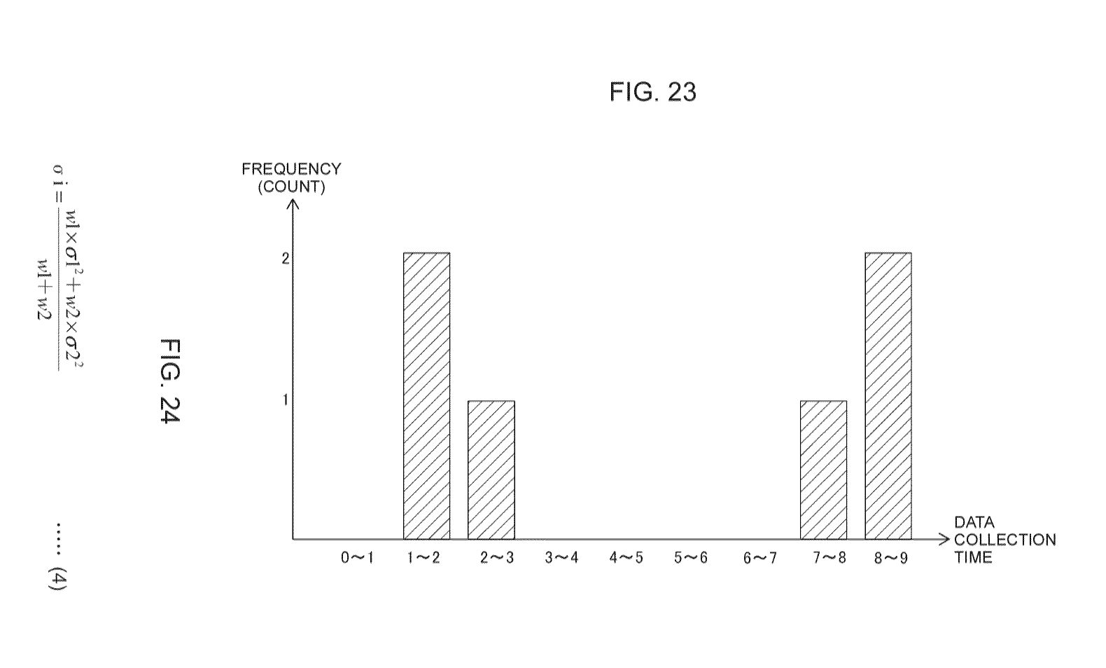

For example, when the name (sensor type) of the time series data source 2 of the selection object designated in the analytical query 11 is “temperature sensor”, and the histogram of the transfer time is to be created at 1-minute intervals between 0 minutes to 9 minutes, the histogram will be, as shown in FIG. 23, 0 for those in which the transfer time is 0 minutes or more and less than 1 minute. 2 for those in which the transfer time is 2 minutes or more and less than 3 minutes, 1 for those in which the transfer time is 3 minutes or more and less than 4 minutes, 2 for those in which the transfer time is 7 minutes or more and less than 8 minutes, 2 for those in which the transfer time is 8 minutes or more and less than 9, and 0 for those in which the transfer time is other than the above.

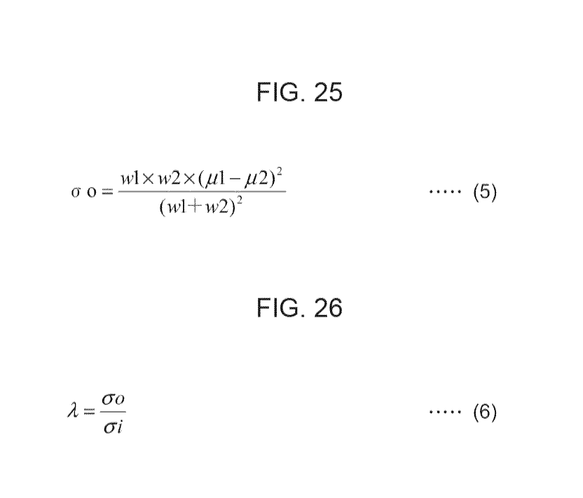

Subsequently, the transfer time determining factor determination unit 74 calculates the factor determination time T to become the reference (threshold) upon sorting the time series data 10 to either group (SP71). Specifically, when the number of elements is w1, the average is μ1, and the distribution is σ1 of the group that is not greater than the factor determination time T, and the number of elements is w2, the average is μ2, and the distribution is σ2 of the group that is greater than the factor determination time T, the transfer time determining factor determination unit 74 calculates the intragroup distribution σi based on the arithmetic expression shown in FIG. 24, calculates the inter-group distribution σo based on the arithmetic expression shown in FIG. 25, and calculates, as the factor determination time T, the time that will maximize the degree of separation λ between the groups based on the arithmetic expression shown in FIG. 26 by using the calculated intragroup distribution σi and the inter-group distribution σo.

For example, when the histogram of FIG. 23 is to be sorted into two groups of “5 minutes or less” and “greater than 5 minutes”, the number of elements is 3, the average μ1 is 2.3, and the distribution σ1 is 0.22 of the group of “5 minutes or less”, and the number of elements is 3, the average μ2 is 7.7, and the distribution σ2 is 0.22 of the group of “greater than 5 minutes”. Accordingly, in the foregoing case, the intragroup distribution σi is calculated as being 0.048 based on the Formula (4) shown in FIG. 24 and the inter-group distribution σo is calculated as being 7.29 based on the Formula (5) shown in FIG. 25, respectively, and, consequently, the degree of separation λ is calculated as being 151.8 based on the Formula (6) shown in FIG. 26. The transfer time determining factor determination unit 74 performs the foregoing arithmetic operation from 0 minutes to 9 minutes while increasing 1 minute at a time, and sets the time in which the degree of separation λ becomes the maximum value as the factor determination time T.

Subsequently, the transfer time determining factor determination unit 74 determines whether the transfer time of the targeted time series data 10 is greater than the factor determination time T calculated in step SP71 (SP72). Note that, since the target time series data 10 has not yet arrived at the time series data processing apparatus 71 in the foregoing case, the transfer time determining factor determination unit 74 executes the processing of SP72 by using a value obtained by subtracting the scheduled acquisition time (scheduled measurement time) of the measured value stored in that time series data 10 from the current time as the transfer time of the time series data 10. Also in step SP73 and step SP75 explained below, the term “transfer time” shall include the transfer time that was calculated as described above.

When a negative result is obtained in the foregoing determination, the arrival time prediction unit 37 calculates the average value of the transfer time in the group in which the transfer time is not greater than the factor determination time T. Moreover, the arrival time prediction unit 37 uses the calculated average value of the transfer time and calculates the predicted arrival time of the targeted time series data 10 according to the corresponding calculation method stored in the arrival time prediction model table 75 (FIG. 20) (SP73).

Thereafter, the query processing unit 35 additionally registers, in the query result 12, the measurement time, the predicted arrival time and the transfer time determining factor (for instance, communication delay) regarding that time series data 10 (SP74). The data analyzing unit 73 thereafter ends the data transfer time determining factor determination processing, and returns to the query result creation processing (FIG. 21).

Meanwhile, when a negative result is obtained in the determination of step SP72, the arrival time prediction unit 37 calculates the average value of the transfer time in the group in which the transfer time is greater than the factor determination time T. Moreover, the arrival time prediction unit 37 uses the calculated average value of the transfer time and calculates the predicted arrival time of the targeted time series data 10 according to the corresponding calculation method stored in the arrival time prediction model table 75 (SP75).

Thereafter, the query processing unit 35 additionally registers, in the query result 12, the measurement time, the predicted arrival time and the transfer time determining factor (for instance, temporary communication failure) regarding that time series data 10 (SP76). The data analyzing unit 73 thereafter ends the data transfer time determining factor determination processing, and returns to the query result creation processing.

### (3-3) Effect of the Present Embodiment

With the computer system 70 according to the present embodiment described above, since the transfer time determining factor of the not-yet-arrived time series data 10 is determined, and the predicted arrival time of the not-yet-arrived time series data 10 is calculated by using only the information obtained from the time series data 10 having a similar transfer time determining factor, are more accurate predicted arrival time can be obtained.

Accordingly, in addition to the same effect as the computer system 1 according to the first embodiment, the computer system 70 can additionally yield the effect of being able to provide highly accurate information (predicted arrival time) to the time series data utilization device 3 and the like.

### (4) Other Embodiments

Note that the foregoing first to third embodiments described a case where the time series data source 2 is a sensor, but the present invention is not limited thereto, and other devices in addition to a sensor that periodically output some kind of data may also be broadly applied as the time series data source 2.

Moreover, the foregoing first to third embodiments described a case of applying the memory 22 configured from a RAM or the like as the storage medium for storing the computer programs to be executed in the time series data processing apparatuses 4, 61, 71 that process the time series data 10, which is series of data sent from the time series data source 2 over time, the present invention is not limited thereto, and, for example, disk-shaped storage mediums such as a CD (Compact Disc), a DVD (Digital Versatile Disc), a BD (Blu-ray Disc), or a hard disk, or other various storage mediums may be broadly applied.

Furthermore, the foregoing third embodiment explained a case of dividing the time series data 10 into two groups depending on the transfer time, but the present invention is not limited thereto, and the time series data 10 may also be divided into three or more groups.

### INDUSTRIAL APPLICABILITY

The present invention can be broadly applied to a time series data processing apparatus of various configurations for processing time series data.

### REFERENCE SIGNS LIST

1, 60, 70 . . . computer system, 2 . . . time series data source, 3 . . . time series data utilization device, 4, 61, 71 . . . time series data processing apparatus, 10 . . . time series data, 11 analytical query, 12 query result, 21 . . . processor, 22 . . . memory, 26, 62, 72 time series data processing program, 27, 69 . . . data table with arrival time, 28, 67 . . . measurement time rule table, 29, 68, 75 . . . arrival time prediction model table, 30, 63 data collection unit, 31, 65, 73 . . . data analyzing unit, 40 . . . data analysis screen.

1. A time series data processing apparatus for processing time series data, which is series of data sent from a data source over time, comprising:
an arrival time assignment unit for assigning an arrival time, which is a time that the time series data arrived, to the time series data sent from the data source;
a data arrival determination unit for determining whether the requested time series data has arrived; and
an arrival time prediction unit for predicting the arrival time of the time series data, which was determined by the data arrival determination unit as not yet arrived, based on the arrival time assigned to each of the time series data.

2. The time series data processing apparatus according to claim 1,
wherein the data source:
periodically acquires a measured value, and sends, to the time series data processing apparatus, the time series data storing the acquired measured value and a measurement time indicating a time that the measured value was acquired,
wherein the data arrival determination unit:
stores in advance a measurement time interval as a time interval that the data source is to acquire the measured value, and a measurement start time as a time that the data source starts acquiring the measured value; and
determines whether the requested time series data has arrived based on the measurement time interval and the measurement start time, and the measurement time stored in each of the arrived time series data.

3. The time series data processing apparatus according to claim 1,
wherein the data source:
periodically acquires a measured value, and sends, to the time series data processing apparatus, the time series data storing the acquired measured value and a measurement time indicating a time that the measured value was acquired,
wherein the arrival time prediction unit:
calculates an average value of time from a time that the data source acquired the measured value to a time that the measured time arrives based on a measurement time stored in each of the arrived time series data, and the arrival time assigned to each of the time series data; and
predicts an arrival time of the requested time series data, which has not yet arrived, based on the calculated average value.

4. The time series data processing apparatus according to claim 1,
wherein the data source:
periodically acquires a measured value, and collectively sends at a predetermined transfer time, to the time series data processing apparatus, the time series data storing the acquired measured value and a measurement time indicating a time that the measured value was acquired,
wherein the time series data processing apparatus further comprises:
a transfer time assignment unit for storing in advance the transfer time that the data source will collectively send the time series data, and assigning the corresponding transfer time to the time series data sent from the data source,
wherein the arrival time prediction unit:
calculates an average value of time from a time that the data source sent the time series data to a time that the time series data arrives based on the arrival time and the transfer time respectively assigned to each of the time series data; and
predicts an arrival time of the requested time series data, which has not yet arrived, based on the calculated average value.

5. The time series data processing apparatus according to claim 1,
wherein the data source:
periodically acquires a measured value, and sends, to the time series data processing apparatus, the time series data storing the acquired measured value and a measurement time indicating a time that the measured value was acquired, and
wherein the time series data processing apparatus further comprises:
a transfer time determining factor determination unit for determining a transfer time determining factor, which is a factor as a time required from a time that the data source acquired the measured value to a time that the time series data storing the measured value arrives at the time series data processing apparatus,
wherein the transfer time determining factor determination unit:
upon dividing each of the arrived time series data into a plurality of groups according to the transfer time determining factor, determines to which group the time series data, which was determined by the data arrival determination unit as not yet arrived, belongs,
wherein the arrival time prediction unit:
based on a measurement time stored in each of the arrived time series data belonging to a group that was determined as the group to which the time series data, which was determined as not yet arrived, belongs, and the arrival time assigned to each of the time series data, calculates an average value of time from a time that the data source acquired the measured value to a time that the measured time arrives regarding the group; and
predicts an arrival time of the requested time series data, which has not yet arrived, based on the calculated average value.

6. A time series data processing method that is executed in a time series data processing apparatus for processing time series data, which is series of data sent from a data source over time, comprising:
a first step whereby the time series data processing apparatus assigns an arrival time, which is a time that the time series data arrived, to the time series data sent from the data source;
a second step whereby the time series data processing apparatus determines whether the requested time series data has arrived; and
a third step whereby the time series data processing apparatus predicts the arrival time of the time series data, which was determined by the data arrival determination unit as not yet arrived, based on the arrival time assigned to each of the time series data.

7. The time series data processing method according to claim 6,
wherein the data source:
periodically acquires a measured value, and sends, to the time series data processing apparatus, the time series data storing the acquired measured value and a measurement time indicating a time that the measured value was acquired, and
wherein the time series data processing apparatus:
stores in advance a measurement time interval as a time interval that the data source is to acquire the measured value, and a measurement start time as a time that the data source starts acquiring the measured value; and
wherein, in the third step, the time series data processing apparatus:
determines whether the requested time series data has arrived, based on the measurement time interval and the measurement start time, and the measurement time stored in each of the arrived time series data.

8. The time series data processing method according to claim 6,
wherein the data source:
periodically acquires a measured value, and sends, to the time series data processing apparatus, the time series data storing the acquired measured value and a measurement time indicating a time that the measured value was acquired,
wherein, in the third step, the time series data processing apparatus:
calculates an average value of time from a time that the data source acquired the measured value to a time that the measured time arrives based on a measurement time stored in each of the arrived time series data, and the arrival time assigned to each of the time series data; and
predicts an arrival time of the requested time series data, which has not yet arrived, based on the calculated average value.

9. The time series data processing method according to claim 6,
wherein the data source:
periodically acquires a measured value, and collectively sends at a predetermined transfer time, to the time series data processing apparatus, the time series data storing the acquired measured value and a measurement time indicating a time that the measured value was acquired,
wherein the time series data processing apparatus:
stores in advance the transfer time that the data source will collectively send the time series data, and assigns the corresponding transfer time to the time series data sent from the data source,
wherein, in the third step, the time series data processing apparatus:
calculates an average value of time from a time that the data source sent the time series data to a time that the time series data arrives based on the arrival time and the transfer time respectively assigned to each of the time series data; and
predicts an arrival time of the requested time series data, which has not yet arrived, based on the calculated average value.

10. The time series data processing method according to claim 6,
wherein the data source:
periodically acquires a measured value, and sends, to the time series data processing apparatus, the time series data storing the acquired measured value and a measurement time indicating a time that the measured value was acquired,
wherein, in the third step, the time series data processing apparatus:
determines a transfer time determining factor, which is a factor as a time required from a time that the data source acquired the measured value to a time that the time series data storing the measured value arrives at the time series data processing apparatus;
upon dividing each of the arrived time series data into a plurality of groups according to the transfer time determining factor, determines to which group the time series data, which was determined by the data arrival determination unit as not yet arrived, belongs;
based on a measurement time stored in each of the arrived time series data belonging to a group that was determined as the group to which the time series data, which was determined as not yet arrived, belongs, and the arrival time assigned to each of the time series data, calculates an average value of time from a time that the data source acquired the measured value to a time that the measured time arrives regarding the group; and
predicts an arrival time of the requested time series data, which has not yet arrived, based on the calculated average value.

11. A storage medium storing a computer program to be executed in a time series data processing apparatus for processing time series data, which is series of data sent from a data source over time,
wherein the computer program causes the time series data processing apparatus to execute:
a first step of assigning an arrival time, which is a time that the time series data arrived, to the time series data sent from the data source;
a second step of determining whether the requested time series data has arrived; and
a third step of predicting the arrival time of the time series data, which was determined by the data arrival determination unit as not yet arrived, based on the arrival time assigned to each of the time series data.

12. The storage medium according to claim 11,
wherein the data source:
periodically acquires a measured value, and sends, to the time series data processing apparatus, the time series data storing the acquired measured value and a measurement time indicating a time that the measured value was acquired,
wherein the time series data processing apparatus:
stores in advance a measurement time interval as a time interval that the data source is to acquire the measured value, and a measurement start time as a time that the data source starts acquiring the measured value;
wherein, in the third step, the time series data processing apparatus:
determines whether the requested time series data has arrived based on the measurement time interval and the measurement start time, and the measurement time stored in each of the arrived time series data.

13. The storage medium according to claim 11,
wherein the data source:
periodically acquires a measured value, and sends, to the time series data processing apparatus, the time series data storing the acquired measured value and a measurement time indicating a time that the measured value was acquired,
wherein, in the third step, the time series data processing apparatus:
calculates an average value of time from a time that the data source acquired the measured value to a time that the measured time arrives based on a measurement time stored in each of the arrived time series data, and the arrival time assigned to each of the time series data; and
predicts an arrival time of the requested time series data, which has not yet arrived, based on the calculated average value.

14. The storage medium according to claim 11,
wherein the data source:
periodically acquires a measured value, and collectively sends at a predetermined transfer time, to the time series data processing apparatus, the time series data storing the acquired measured value and a measurement time indicating a time that the measured value was acquired,
wherein the time series data processing apparatus:
stores in advance the transfer time that the data source will collectively send the time series data, and assigns the corresponding transfer time to the time series data sent from the data source,
wherein, in the third step, the time series data processing apparatus:
calculates an average value of time from a time that the data source sent the time series data to a time that the time series data arrives based on the arrival time and the transfer time respectively assigned to each of the time series data; and
predicts an arrival time of the requested time series data, which has not yet arrived, based on the calculated average value.

15. The storage medium according to claim 11,
wherein the data source:
periodically acquires a measured value, and sends, to the time series data processing apparatus, the time series data storing the acquired measured value and a measurement time indicating a time that the measured value was acquired,
wherein, in the third step, the time series data processing apparatus:
determines a transfer time determining factor, which is a factor as a time required from a time that the data source acquired the measured value to a time that the time series data storing the measured value arrives at the time series data processing apparatus;
upon dividing each of the arrived time series data into a plurality of groups according to the transfer time determining factor, determines to which group the time series data, which was determined by the data arrival determination unit as not yet arrived, belongs;
based on a measurement time stored in each of the arrived time series data belonging to a group that was determined as the group to which the time series data, which was determined as not yet arrived, belongs, and the arrival time assigned to each of the time series data, calculates an average value of time from a time that the data source acquired the measured value to a time that the measured time arrives regarding that group; and
predicts an arrival time of the requested time series data, which has not yet arrived, based on the calculated average value.
